(19) United States
(12) Patent Application Publication
(10) Pub. No.: US 2023/0098988 A1
(43) Pub. Date: Mar. 30, 2023

(54) User-Centered Motion Planning In A Mobile Ecosystem

(71) Applicant: Apple Inc., Cupertino, CA (US)

(72) Inventors: Walter Rosinger, Los Altos, CA (US); Manfred A. Harrer, Mountain View, CA (US)

(21) Appl. No.: 17/873,479

(22) Filed: Jul. 26, 2022

Related U.S. Application Data
(60) Provisional application No. 63/246,388, filed on Sep. 21, 2021.

(51) Int. Cl. B60W 60/00

(52) U.S. Cl. CPC B60W 60/0013; B60W 2510/18; B60W 2510/20; B60W 2510/22; B60W 2510/30; B60W 2540/215; B60W 2552/00; B60W 2554/00; B60W 2556/10; B60W 2556/45

(57) ABSTRACT

A mobile ecosystem includes an autonomous control system in a vehicle. The autonomous control system receives user information from at least one of a user device or the vehicle and identifies a trajectory plan and a vehicle configuration based on the user information. The trajectory plan identifies a departure time for the vehicle to depart a starting location, an arrival time for the vehicle to arrive at a destination location, and a travel route for the vehicle to traverse at least partially between the starting location and the destination location. The trajectory plan may identify an entry time for the user to enter the vehicle. The vehicle configuration identifies travels settings for components in at least one of dynamic systems or interior systems of the vehicle. The autonomous control system causes the components to be configured according to the travel settings and causes the vehicle to traverse the travel route.

### CROSS-REFERENCE TO RELATED APPLICATION(S

This application claims the benefit of U.S. Provisional Pat. Application No. 63/246,388 filed on Sep. 21, 2021, the content of which is hereby incorporated by reference in its entirety for all purposes.

### TECHNICAL FIELD

This disclosure relates generally to vehicle control and specifically to user-centered motion planning for a vehicle (e.g., a mobility device).

### BACKGROUND

Traditional routing systems for a vehicle (e.g., a mobility device), such as mapping applications, can offer routing options that vary a navigation route for a vehicle. A driver or passenger can provide inputs as to preferences for traveling fast routes, short routes, highway-based routes, highway-free routes, etc. Selection of the navigation route by the routing system can be based both on the inputs from the driver or passenger and a routing metric, such as a metric that gives weight to routing factors such as estimated time to traverse a route, total distance to a destination, and types of roadways on a route (e.g., numbers of lanes, frequency of traffic signals, etc.).

With the advent of automated driving functions, a vehicle can transform from solely a means of transportation to a living and working space for a user. Thus, the vehicle will need to balance offering both an efficient means of transportation and a comfortable living and working space for the user. These requirements can conflict, for example, as living and working spaces may be most comfortable with a lowest level of perceived cabin motion and vibration at low travel speeds with potentially longer routes while time efficient transportation may include higher travel speeds that can introduce more motion and vibration into a vehicle.

### SUMMARY

A first aspect of the disclosed embodiments is a mobile ecosystem. The mobile ecosystem includes an autonomous control system in a vehicle. The autonomous control system receives user information from at least one of a user device or the vehicle and identifies a trajectory plan and a vehicle configuration based on the user information. The trajectory plan identifies a departure time for the vehicle to depart a starting location, an arrival time for the vehicle to arrive at a destination location, and a travel route for the vehicle to traverse at least partially between the starting location and the destination location. The vehicle configuration identifies travels settings for components in at least one of dynamic systems or interior systems of the vehicle. The autonomous control system causes the components to be configured according to the travel settings and causes the vehicle to traverse the travel route.

In the first aspect, the autonomous control system may be further configured to cause the components to be configured according to the travel settings prior to causing the vehicle to traverse the travel route. The user information may include at least one of a user location, user calendar information, user biometric information, user location history information, user entertainment information, or user preference information. The trajectory plan may identify an entry time for a user to enter the vehicle based on at least one of the user entertainment information or the user calendar information, the entry time prior to the departure time. The autonomous control system may be further configured to receive updated user information from at least one of the user device or the vehicle and identify an updated vehicle configuration based on the updated user information. The updated vehicle configuration may identify updated travel settings for one or more components in the at least one of the dynamic systems or the interior systems of the vehicle. The autonomous control system may be further configured to cause the one or more components to be configured according to the updated travel settings. The autonomous control system may be further configured to identify an updated trajectory plan based on the updated user information, the updated trajectory plan identifying an updated travel route, and cause the vehicle to traverse the updated travel route. The autonomous control system may be further configured to receive vehicle information from the vehicle. The vehicle information may include at least one of infrastructure information, route terrain information, route traffic information, a vehicle location, or vehicle location history information. The autonomous control system may be further configured to cause the user device or the vehicle to generate a user alert based on at least one of the user information or the vehicle information. The user alert may include a change suggestion, and the autonomous control system may be further configured to cause the user device or the vehicle to present the change suggestion to the user. Upon a condition that the user ratifies the change suggestion, the autonomous control system may be further configured to identify an updated trajectory plan that identifies at least one of an updated departure time, an updated arrival time, or an updated travel route between the starting location and the destination location based on the change suggestion and cause the vehicle to traverse the updated travel route. The autonomous control system may be further configured to, upon a condition that the user ratifies the change suggestion, identify an updated vehicle configuration based on the change suggestion. The updated vehicle configuration may identify updated travel settings for one or more components in the at least one of the dynamic systems or the interior systems of the vehicle. The autonomous control system may be further configured to cause the one or more components to be configured according to the updated travel settings. The various features of the first aspect described in this paragraph can be implemented together or separately.

A second aspect of the disclosed embodiments is a motion-planning method. The motion-planning method includes obtaining user information from at least one of a user device or a vehicle, obtaining vehicle information from at least one of the user device or the vehicle, and identifying a trajectory plan and a vehicle configuration based on the user information and the vehicle information. The trajectory plan identifies a travel route for the vehicle to traverse at least partially between a starting location and a destination location. The vehicle configuration identifies travels settings for components in at least one of dynamic systems or interior systems of the vehicle. The motion-planning method includes configuring the components according to the travel settings and, after configuring the components according to the travel settings, causing the vehicle to traverse the travel route.

In the second aspect, the motion-planning method may further comprise obtaining updated user information from at least one of the user device or the vehicle, sending a change suggestion to one of the user device or the vehicle, and upon a condition that a user ratifies the change suggestion, identifying an updated vehicle configuration based on the updated user information. The updated vehicle configuration may identify updated travel settings for one or more components in the dynamic systems or the interior systems of the vehicle. The motion-planning method may further comprise configuring the one or more components according to the updated travel settings. The motion-planning method may further comprise obtaining updated vehicle information from the vehicle, sending a change suggestion to one of the user device or the vehicle, upon a condition that a user ratifies the change suggestion, identifying an updated travel route for the vehicle to traverse at least partially between the starting location and the destination location, and causing the vehicle to traverse the updated travel route. The user information may include at least one of a user location, user calendar information, user biometric information, user location history information, user entertainment information, or user preference information. The trajectory plan may identify a departure time for the vehicle to depart the starting location, an arrival time for the vehicle to arrive at the destination location, and an entry time for a user to enter the vehicle based on at least one of the user calendar information or the user entertainment information, the entry time being prior to the departure time. The motion-planning method may further comprise sending a user alert to the user device, the user alert configured to identify the entry time for the user to enter the vehicle. The vehicle information may include at least one of infrastructure information, route terrain information, route traffic information, a vehicle location, or vehicle location history information. The various features of the second aspect described in this paragraph can be implemented together or separately.

A third aspect of the disclosed embodiments is an autonomous control system for a vehicle. The autonomous control system is configured to obtain user information pertaining to a user of the vehicle, obtain vehicle information pertaining to the vehicle, and identify a vehicle configuration based on at least one of the user information or the vehicle information. The vehicle configuration identifies travels settings for components in at least one of dynamic systems or interior systems of the vehicle. The autonomous control system is further configured to cause the components to be configured according to the travel settings.

In the third aspect, the vehicle configuration may identify travel settings for components in the dynamic systems, and the travel settings may include at least one of suspension settings, powertrain settings, steering settings, or braking settings. The vehicle configuration may identify travel settings for components in the interior systems, and the travel settings may include at least one lighting levels, climate control settings, tinting settings, audio settings, and positions of seats within the vehicle. The various features of the third aspect described in this paragraph can be implemented together or separately.

### BRIEF DESCRIPTION OF THE DRAWINGS

The disclosure is best understood from the following detailed description when read in conjunction with the accompanying drawings.

FIG. 1 is a block diagram of a mobile ecosystem.

FIG. 2 is flowchart describing a user-centered motion planning process using the mobile ecosystem of FIG. 1.

FIG. 3 is another flowchart describing a user-centered motion planning process using the mobile ecosystem of FIG. 1.

FIG. 4 is a calendar view for devices in the mobile ecosystem of FIG. 1.

FIG. 5 is a block diagram of a vehicle.

### DETAILED DESCRIPTION

A mobile ecosystem that includes both a vehicle (e.g., a mobility device) and a user device can leverage user information and vehicle information (e.g., mobility information) to provide user-centered motion planning and a comfortable living and working space for a user within a vehicle cabin. An autonomous control system associated with the vehicle can leverage available information to intelligently configure various components within vehicle systems (e.g., mobility systems) according to travel settings that support different vehicle configurations (e.g., mobility configurations) to better match user activity within the vehicle. Vehicle configurations may include relaxation configurations that support the user watching movies or comfortably resting, work configurations that support the user reading, making calls, or writing on a work surface, range configurations that support energy efficiency, and sprint configurations that support the user rapidly traveling from a starting location to a destination location. The user-centered motion planning process can be dynamic, with continuous updates based on user information and vehicle information (e.g., mobility information) available to the autonomous control system.

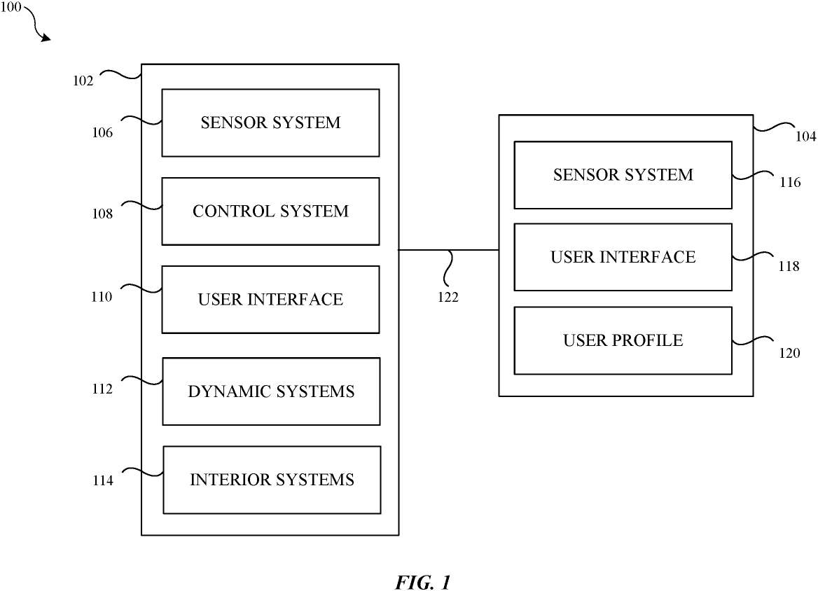

FIG. 1 is a block diagram of a mobile ecosystem 100 suitable to implement the motion-planning methods described herein. The mobile ecosystem may include a vehicle 102 (e.g., a mobility device 102) and a user device 104. Though a single vehicle 102 and a single user device 104 are shown, multiple vehicles or multiple user devices may be part of the mobile ecosystem 100.

The vehicle 102 may include a sensor system 106, an autonomous control system 108, a user interface 110, dynamic systems 112, and interior systems 114. Components within these systems 106, 108, 110, 112, 114 may form a physical structure of the vehicle 102 (not shown). The systems 106, 108, 110, 112, 114 can be electrically interconnected to allow transmission of signals, data, commands, etc., either over wired connections such as a communications bus (not shown) or over wireless data communications channels. Conventional components of other types may also be included in the vehicle 102.

The user device 104 may include a sensor system 116, a user interface 118, and a user profile 120. These components are electrically interconnected within the user device 104 to allow transmission of signals, data, commands, etc. between them, either over wired connections such as a communications bus (not shown) or over wireless data communications channels. Conventional components of other types may be included in the user device 104. The user device 104 can communicate with the vehicle 102 via a network 122 that can include any manner of wired or wireless interface that allows the user device 104 to communicate with the vehicle 102, such as by sending data transmissions and receiving data transmissions.

The sensor system 106 of the vehicle 102 may capture or receive information which is referred to as vehicle information (e.g., mobility information). Vehicle information can relate both to components of the vehicle 102 and to an environment where the vehicle 102 is located. The environment can be an exterior of the vehicle 102, an interior of the vehicle 102, or an area surrounding the vehicle 102. Vehicle information captured or received by the sensor system 106 can relate to other vehicles nearby the vehicle 102, pedestrians and/or objects in the environment, operating conditions of the vehicle 102, operating conditions or trajectories of other vehicles, and other conditions within the vehicle 102 or exterior to the vehicle 102.

For example, vehicle information may include a vehicle location of the vehicle 102 or vehicle location history information indicative of historical locations visited by the vehicle 102. Vehicle information may include route traffic information indicative of traffic around the vehicle 102 or on a planned route for the vehicle 102. Vehicle information may include route terrain information indicative of road conditions around the vehicle 102 or on a planned route for the vehicle 102 such as speed bumps, potholes, gravel, etc. Vehicle information may include travel settings for various components within the vehicle 102, where together the various travel settings may be referred to as a vehicle configuration or a mobility configuration. Changeable travel settings can include suspension settings, powertrain settings, steering settings, and braking settings within the dynamic systems 112 of the vehicle 102 as well as lighting levels, climate control settings, window settings, audio settings, entertainments settings, and seating settings within the interior systems 114. This list of travel settings is not exhaustive as additional travel settings are possible.

The sensor system 116 of the user device 104 or the sensor system 106 of the vehicle 102 may also capture or receive information about the user of the user device 104 or the user of the vehicle 102 which is referred to as user information. The sensor systems 106, 116 can include sensors such as an accelerometer, a gyroscope, a still image camera, a video camera, an infrared sensor, a light detection and ranging (LIDAR) system, a radar system, a sonar system, a thermometer, a barometer, a moisture sensor, a vibration sensor, a capacitive input sensor, a resistive input sensor, or any other sensor suitable to capture or receive information about the user.

User information may include a user location, user location history information, user calendar information, user biometric information, or user entertainment information. User location can refer to a physical location of the user based on recognition of the user within an image or based on a location of the user device 104, for example, as held or placed nearby the user. The user location may also be determined by identifying a position of a user within the vehicle 102 based on information supplied from the sensor system 106 of the vehicle 102. User location history information can include historical locations of the user device 104 or historical locations of the user within the vehicle 102.

User biometric information may identify physical or emotional features of the user. For example, user biometric information can refer to a physiological status of the user and can include information relating to a heart rate, a drowsiness level, or other physical or emotional features of the user. User biometric information can be used to identify a mood or physical response by the user, such as closed eyes of the user indicating drowsiness or sleep, a loss of color in the face or prolonged frowning indicating queasiness, a knitted brow or clenched lips indicated concern or discomfort, etc.

User information can also be collected via the user interfaces 110, 118 of the vehicle 102 or the user device 104. The user interfaces 110, 118 can include any type of human-machine interface such as buttons, switches, touch-sensitive input devices, audio devices, display screens, or gestural devices suitable to receive input from a user of the vehicle 102 or the user device 104. A user can interact with one or more of the user interfaces 110, 118, for example, to provide information to the vehicle 102 or the user device 104 about appointments on a user calendar (not shown) or about user preferences related to route planning, trajectory planning, user comfort, and vehicle configuration, i.e., travel settings or mobility configurations, for the dynamic systems 112 or the interior systems 114.

User calendar information can include a schedule of meetings or events for a user as well as locations, participants, and times for the meetings or events. User location history information can include mapping information representative of places where the user has traveled and time information representative of timing and patterns of user travel to such places (e.g., the user meets his boss for lunch every Thursday afternoon around 12:30PM). User entertainment information can include information related to streaming services, audio accounts, or video accounts associated with the user and user activities related to said services or accounts. User preference information can include user-indicated travel settings for the vehicle 102 that impact the dynamic systems 112 and the interior systems 114, such as preferences for seating settings, climate control settings, mirror positions, window tinting, radio stations, acceleration settings, lane-change settings, braking settings, suspension settings, etc.

User information can be collected via and stored within the user profile 120 of the user device 104. That is, the user profile 120 can store user preferences and user activities, both current and historical. The user information within the user profile 120 can include user calendar information, user biometric information, user location history information, user entertainment information, and/or user preference information.

The autonomous control system 108 can be implemented to move the vehicle 102 automatically (e.g., without a driver) using multiple components including hardware components and/or software components. As an example, the autonomous control system 108 can be implemented in the form of one or more computing devices that are provided with control software. The control software includes computer program instructions that allow the autonomous control system 108 to perform the functions that are described herein. The control software can exchange data with a remote computing system via the network 122.

The remote computing system (not shown) can include computing devices such as server computing devices and client computing devices, and each of the computing devices can include a processor, a memory, and a communication interface that can be used to exchange data through the network 122. For example, remote computing systems can operate via wire or wirelessly, be terrestrially based (e.g., in a cellular tower) or non-terrestrially based (e.g., in an orbiting satellite), and can include one or more network access devices such as a router, a hub, a relay, or a switch. The remote computing systems can store data, such as geolocation data, which can be exchanged with the autonomous control system 108 of the vehicle 102.

The autonomous control system 108 is configured to use both user information and vehicle information, such as based on sensor outputs from the sensor systems 106, 116, provided through the user interfaces 110, 118, accessed in the user profile 120, or provided from remote computing systems, to understand a user’s schedule, navigate an environment in which the vehicle 102 operates, and support user-centered motion planning for the vehicle 102. For example, the autonomous control system 108 is configured to identify a trajectory plan for the vehicle 102. The trajectory plan can include a travel route that identifies a path, or a partial path, between various starting locations and destination locations, speed or velocity profiles along the path, lane-changing and over-taking settings along the path, and other travel settings for components within the dynamic systems 112 and the interior systems 114 along the path for the vehicle 102.

The dynamic systems 112 include components (e.g., actuators, motors, brakes, shocks, batteries, axles, wheels, etc.) that cause the vehicle 102 to move. For example, the dynamic systems 112 may include a combustion engine and/or an electric motor and a battery that is configured to propel the vehicle 102, such as by providing drive torque to one or more wheels (not shown). In another example, the dynamic systems 112 may include a steering column (and optional steering wheel) configured to turn the vehicle 102, such as by providing turn angles to one or more wheels (not shown). In another example, the dynamic systems 112 may include an active or semi-active suspension system. The dynamic systems 112 can be controlled by commands received from the autonomous control system 108. The autonomous control system 108 can output commands to the dynamic systems 112 that cause movement of the vehicle 102 in accordance with a path or trajectory route, e.g., a travel route, such as by causing the vehicle 102 to travel from a starting location to a destination location with predetermined travel settings for components within the dynamic systems 112.

The interior systems 114 include climate components having travels settings changeable to deliver heating and cooling matching user preferences, lighting components changeable to deliver various levels of illumination, windows changeable to deliver various levels of tint or airflow, entertainment systems changeable to provide audio and video entertainment or audio or video conferencing, seats having seat backs rotatable with respect to seat pans, seats rotatable or translatable with respect to other seats, table systems or other surfaces configurable to provide entertainment or working surfaces, and other components that can be moved, positioned, or otherwise configured to meet user-specific preferences or travel settings that impact components within the interior systems 114 of the vehicle 102. Though only dynamic systems 112 and interior systems 114 are described in the examples of components controlled by commands received from the autonomous control system 108, other components of the vehicle 102 may have changeable travel settings consistent with achieving several vehicle configurations (e.g., mobility configurations).

One example of a vehicle configuration is a sprint configuration where the autonomous control system 108 identifies a trajectory plan to navigate a predetermined travel route for the vehicle 102 in a fast, efficient manner that minimizes a time is takes to arrive at a destination location. In the sprint configuration, the autonomous control system 108 can send commands to the dynamic systems 112 and/or the interior systems 114 to operate using travel settings that support speed for the vehicle 102. In the sprint configuration, passenger comfort may be of lower priority than speed in reaching a destination location.

Another example of a vehicle configuration is a work configuration where the autonomous control system 108 identifies a trajectory plan to navigate a predetermined travel route for the vehicle in a smooth, low-vibration manner that reduces a number of lane changes, a number of stops and starts, and acceleration and deceleration rates. In the work configuration, the autonomous control system 108 can send commands to the dynamic systems 112 to operate using travel settings that support comfort and ride quality and to the interior systems 114 to operate using travel settings that support, for example, ample lighting and user access to a work surface within an interior of the vehicle 102.

Another example of a vehicle configuration is a relaxation configuration where the autonomous control system 108 identifies a trajectory plan to navigate a predetermined travel route for the vehicle in a smooth, low-vibration manner that reduces a number of lane changes, a number of stops and starts, and acceleration and deceleration rates. In the relaxation configuration, the autonomous control system 108 can send commands to the dynamic systems 112 to operate using travel settings that support comfort and ride quality and to the interior systems 114 to operate using travel settings that support, for example, low lighting, privacy tint, seat backs positioned in recline, and infotainment options being accessible to the user.

Another example of a vehicle configuration is a range configuration where the autonomous control system 108 identifies a trajectory plan to navigate a predetermined travel route for the vehicle that increases operating efficiency of the vehicle, such as by reducing fuel consumption by an engine or lowering discharge rate of a battery. In the range configuration, the autonomous control system 108 can send commands to the dynamic systems 112 and/or the interior systems 114 to operate using travel settings that support energy efficiency, such as by restricting or controlling use of auxiliary systems that increase fuel consumption or discharge rates of the battery.

The vehicle 102 and the user device 104 communicate via the network 122 to form the mobile ecosystem 100. The vehicle 102, the user device 104, and/or the network 122 (such as including a cloud computing device) can automatically detect transportation needs of the user, including a vehicle configuration, based on user information and/or vehicle information provided by the vehicle 102 and/or the user device 104 in order to improve a user’s travel experience within the vehicle 102. This user-centered solution reduces a number of times the user needs to provide inputs to the vehicle 102 or the user device 104, and in some cases, can eliminate a need for the user to provide inputs to the vehicle 102 or the user device 104 as the autonomous control system 108 learns from previous user inputs or updates to user information, for example, associated with the user profile 120. Various examples of vehicle configurations that may be executed using the mobile ecosystem 100 are described herein.

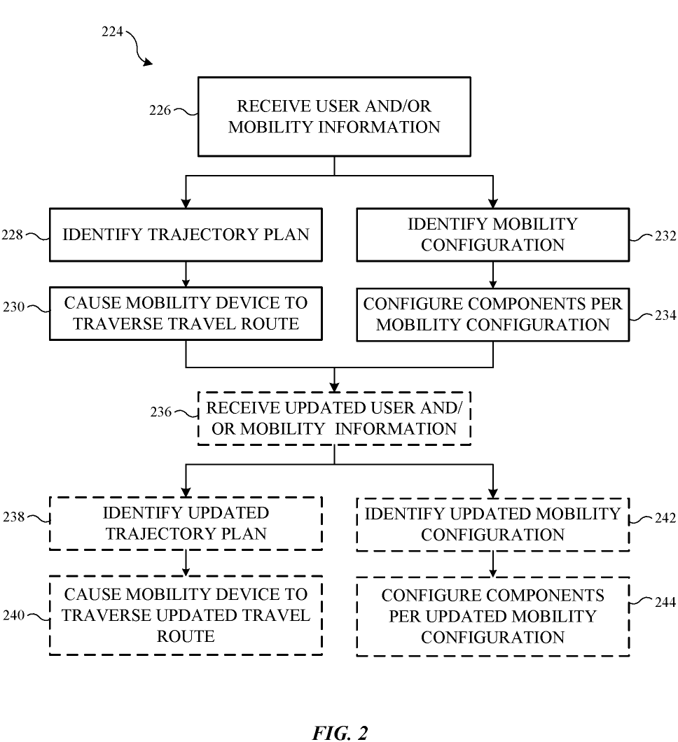

FIG. 2 is flowchart describing a user-centered motion-planning process 224 using the mobile ecosystem 100 of FIG. 1. In step 226 of the process 224, a control system such as the autonomous control system 108 of FIG. 1 can receive or access user information and/or vehicle information (e.g., mobility information) from a user device such as the user device 104 and/or from a vehicle (e.g., a mobility device) such as the vehicle 102 of FIG. 1. The user information may include a user location, user calendar information, user biometric information, user location history information, user entertainment information, or user preference information as described with respect to FIG. 1. The vehicle information may include infrastructure information, route terrain information, route traffic information, a vehicle location, or vehicle location history information as described with respect to FIG. 1. The source of the user information and the vehicle information may vary, that is, in some examples a vehicle may supply user information, such as presence of a user within the vehicle as a user location, and in other examples, a user device may supply vehicle information, such as user preference information related to travel settings for various systems within the vehicle.

Infrastructure information may include construction information related to planned roadwork along roadways, types of materials from which roadways are constructed, or a layout of intersections along various roadways. Infrastructure information may include information related to the presence and location of traffic signals or lighting along roadways as well as resource information related to the presence and location of resources such as charging stations, fuel sources, and public rest-stops that have a physical presence at specific locations along or proximate to roadways. Infrastructure information may also include resource information related to schedules for parking availability, street sweeping, snow removal, or salt or sand application for roadways. Many forms of user information and vehicle information are useful in the user-centered motion planning described with respect to the process 224 of FIG. 2.

In step 228 of the process 224, a control system such as the autonomous control system 108 of FIG. 1 can identify a trajectory plan, based, for example on the user information and/or the vehicle information received or accessed in step 226. The trajectory plan can identify a departure time for a vehicle such as the vehicle 102 of FIG. 1 to depart a starting location, an arrival time for the vehicle to arrive at a destination location, and a travel route for the vehicle to traverse at least partially between the starting location and the destination location. In some examples, the trajectory plan may identify an entry time for a user to enter the vehicle that differs from the departure time. The entry time may be prior to the departure time. In some examples, the trajectory plan may identify an exit time for user to exit the vehicle that differs from the arrival time. The exit time may be after the arrival time. Execution of the trajectory plan may be supported by travel settings associated with a vehicle configuration as described herein.

In step 230 of the process 224, a control system such as the autonomous control system 108 of FIG. 1 can cause the vehicle (e.g., the mobility device) such as the vehicle 102 of FIG. 1 to traverse the travel route of the trajectory plan. For example, traversal of the travel route indicates that the vehicle is caused to follow the pre-determined path or route between the identified starting location and destination location according to the trajectory plan and in line with the optional entry time, the departure them, and the arrival time.

In a parallel arm of the process 224, step 232 includes a control system such as the autonomous control system 108 of FIG. 1 identifying a vehicle configuration (e.g., a mobility configuration) based, for example, on the user information and/or the vehicle information received or accessed in step 226. The vehicle configuration can include travels settings for components in at least one of dynamic systems or interior systems of the vehicle, such as the dynamic systems 112 and the interior systems 114 of the vehicle 102 described with respect to FIG. 1. For example, if the vehicle configuration identifies travel settings for components in the dynamic systems, the travel settings may include at least one of suspension settings, powertrain settings, steering settings, or braking settings. In another example, if the vehicle configuration identifies travel settings for components in the interior systems, the travel settings may include at least one of lighting levels, climate control settings, tinting settings, audio settings, and positions of seats of the vehicle. As described with respect to FIG. 1, travel settings may be grouped or otherwise associated with a variety of vehicle configurations, such as a sprint configuration, a work configuration, a range configuration, or a relaxation configuration for the vehicle.

In step 234 of the process 224, a control system such as the autonomous control system 108 of FIG. 1 can cause the components in the dynamic systems and/or the interior systems of the vehicle to be configured according to the travel settings of the vehicle configuration (e.g., the mobility configuration) identified in step 232.

The steps 228, 230 are shown as occurring in parallel with the steps 232, 234, though the steps 228, 230, 232, 234 may occur in tandem, over a similar time period, over the same time period, or in an alternating manner. For example, the control system may be configured to perform the step 232 of identifying the vehicle configuration prior to performing the step 228 of identifying the trajectory plan. The control system may also be configured to perform the step 234 of configuring various components to have the travel settings of the vehicle configuration prior to performing the step 230 of causing the vehicle to traverse the travel route. The process 224 can be further described by referring to a detailed example.

In a relaxation example of the process 224, a user may be interested in both watching a movie and riding in a vehicle such as the vehicle 102 of FIG. 1 to visit a grandparent. Step 226 of the process 224 can include a control system such as the autonomous control system 108 of FIG. 1 receiving or accessing user information such as calendar information from a calendar application on a user device such as the user device 104 of FIG. 1. The calendar information can indicate both a visit time and a visit location for the grandparent visit. The user information can also include user entertainment information indicating that a user is currently watching (or plans to watch) a movie on a streaming service. Step 226 of the process 224 can also include the control system receiving vehicle information such as a vehicle location, route traffic information, infrastructure information, etc. between the vehicle location and the visit location.

Step 228 of the process 224 can include identifying a trajectory plan for the vehicle based on the user information and/or the vehicle information. In this relaxation example, the control system can identify a starting location, for example, the vehicle location, a departure time, a destination location, for example, the visit location, an arrival time, and a travel route configured to allow some portion of the movie to be viewed by the user in the vehicle before reaching the visit location. Timing coordination is useful if a remainder of the movie on the streaming service is longer than some potential travel routes, but completion of the movie is also important to the user, or the user is flexible as to when departure occurs. The trajectory plan can use the user entertainment information to identify an entry time for the user to enter the vehicle prior to the departure time to allow movie watching to occur in the vehicle without causing the user to be late for the grandparent visit despite spending time watching the movie. For example, the control system may cause a user alert to be sent to the user device prompting the user to enter the vehicle at the entry time to allow for completion of the movie prior to the arrival time, that is, the trajectory plan may account for the user being in the vehicle prior to the departure time to allow for more time to watch the movie in the vehicle. In another example, the trajectory plan can use the calendar information to identify the entry time, such as when the user is interested in making a call along the travel route, but the call is scheduled for a longer time than it takes the vehicle to traverse various travel routes.

Step 232 of the process 224 can include identifying a vehicle configuration for the vehicle based on the user information and/or the vehicle information. In this relaxation example, based on the user entertainment information indicative of the user watching some portion of a movie during the ride to the visit location, the control system can identify a relaxation configuration. In the relaxation configuration, dynamic systems can be operated with travel settings that ensure smooth transitions, low levels of vibration, few lane changes, avoidance of stops and starts, and low acceleration and deceleration rates. In the relaxation configuration, interior systems can be operated with travel settings with lower interior lighting levels, with higher levels of privacy tint on windows to improve viewing quality for the movie, and with comfortably reclined seats that are appropriately spaced with respect to a display surface for the user to view the movie from the streaming service in the vehicle. Various infotainment controls can also be made accessible to the user in the vehicle, either through the user device or through one or more interfaces of the vehicle.

Step 234 of the process 224 can include the control system causing various components within the dynamic systems and/or the interior systems to be configured according to the travel settings associated with the relaxation configuration. In this relaxation example, a display within the vehicle may be uncovered or actuated, the windows may be tinted, the seats may be rotated or reclined, and the movie may begin (or resume) on the display in the vehicle through the streaming service, having been stopped from streaming from a user device. Step 230 of the process 224 can include the control system causing the vehicle to travel from the vehicle location at the departure time, assuming the user is within the vehicle or has been within the vehicle since the entry time, watching the movie. The vehicle will traverse the travel route and arrive at the visit location at the arrival time. Though step 234 of configuring components according to travel settings is described as happening before step 230 of causing the vehicle to traverse the travel route, the steps 230, 234 may occur at the same time or in an opposite order. This relaxation example is described in association with the steps 226, 228, 230, 232, 234 of the process 224. The process 224 can also include additional, optional steps that provide flexibility to the ride experience.

Continuing with optional step 236 of the process 224, the control system can receive updated user information and/or updated vehicle information (e.g., updated mobility information) from the user device and/or the vehicle. In optional step 238 of the process, the control system can identify an updated trajectory plan based on the updated user information. The updated trajectory plan can identify an updated travel route. In optional step 240 of the process 224, the control system can cause the vehicle (e.g., the mobility device) to traverse the updated travel route. In optional step 242 of the process 224, the control system can identify an updated vehicle configuration (e.g., an updated mobility configuration) based on the updated user information and/or the updated vehicle information (e.g., updated mobility information) from optional step 236. The updated vehicle configuration can identify updated travel settings for one or more components in the dynamic systems and/or the interior systems of the vehicle. In optional step 244 of the process 224, the control system can cause the one or more components in the dynamic systems and/or the interior systems to be configured according to the updated travel settings (e.g., according to the updated mobility configuration). The optional steps 236, 238, 240, 242, 244 of the process 224 can be further described by referring to a detailed example.

In a work example of the optional steps 236, 238, 240, 242, 244 of the process 224, the user may be enjoying the movie from the relaxation example while traveling to the visit location when an important call is received by the user device, for example, from a boss of the user (e.g., the boss). In this work example, the optional step 236 of the process 224 can include a control system such as the autonomous control system 108 of FIG. 1 receiving updated user information such as an identity of the boss as associated with the user profile 120 when the user device such as the user device 104 of FIG. 1 receives the call from the boss. Optional step 236 of the process 224 can also include the control system receiving updated vehicle information such as updated infrastructure information from the vehicle such as the vehicle 102 of FIG. 1 that identifies convenient parking locations between a current location of the vehicle and the visit location should the call from the boss be best handled when the vehicle is no longer in motion.

Optional step 238 of the process 224 can include identifying an updated trajectory plan for the vehicle based on the updated user information and/or the updated vehicle information. In this work example, the control system can identify a nearby stopping location for the vehicle along the travel route so that the vehicle may travel to and park in the stopping location to allow the user to talk on the phone with the boss in a stationary vehicle before the vehicle resumes the travel route to the visit location. The change to the travel route is useful if the user prefers to take work calls or meetings in a stationary position, for example, to better take notes, be fully attentive to the call, etc. This preference may be stored as user information in a user profile such as the user profile 120 of the user device 104 of FIG. 1. If the vehicle is near the destination location, the vehicle may travel to and park in the destination location (e.g., the visit location) while the user continues to talk on the phone the boss. The control system can identify an exit time for the user to exit the vehicle, sending an alert or other indication of the exit time to the user such that the user is not late for the grandparent visit.

Optional step 242 of the process 224 can include identifying an updated vehicle configuration for the vehicle based on the updated user information and/or the updated vehicle information. In this work example and based on the user information indicative of the user accepting (or planning to accept) the call from the boss during the ride to the visit location, the control system can identify a work configuration for the vehicle. In the work configuration, the dynamic systems can be controlled to operate with travel settings that ensure smooth transitions, low levels of vibration, few lane changes, avoidance of stops and starts, and low acceleration and deceleration rates. The interior systems may be controlled to operate with travel settings that provide an office-like setting such as increased interior lighting levels, privacy tint implemented for windows and, if present, a sunroof or moonroof of the vehicle, seats in upright positions, a table accessible as a working surface, and infotainment systems with lowered audio levels, made hidden, or made inaccessible to support a quiet work environment.

Optional step 244 of the process 224 can include the control system causing various components within the dynamic systems and/or the interior systems to be configured according to the updated travel settings associated with the work configuration. In this work example, the movie that was playing can be paused or stopped, seats that are reclined can be transitioned to a more upright position, climate control settings can include a quieter blower operation, interior lighting levels can be increased, a display surface that was showing the movie can be covered or switched to a more generic screen-saving option, a stowed work surface or table suitable for writing notes may be deployed, audio systems that are not dedicated to call support can be muted or set to vibrate for notifications, etc. In short, interior systems of the vehicle are controlled to create a professional environment and dynamic systems of the vehicle are controlled to provide a smooth ride or an intermediate stop so that the user may handle the call from the boss.

Once the call is complete, the process 224 may repeat, such as by revisiting step 226 or optional step 236 (not shown) in that the control system may again receive updated user information and/or updated vehicle information from the user device and/or the vehicle, for example, indicative of the call ending. The vehicle may return to the relaxation configuration described with respect to steps 226, 228, 230, 232, 234, including resuming streaming the movie, reclining the seats, and proceeding to the visit location. If work-like user activity is detected, for example, the user is working on a laptop, writing notes, or making additional calls, the vehicle may remain in the work configuration described with respect to optional steps 236, 238, 240, 242, 244 while proceeding to the visit location. The user-centered process 224 of FIG. 2 thus provides responsive flexibility to meet the current needs of the user.

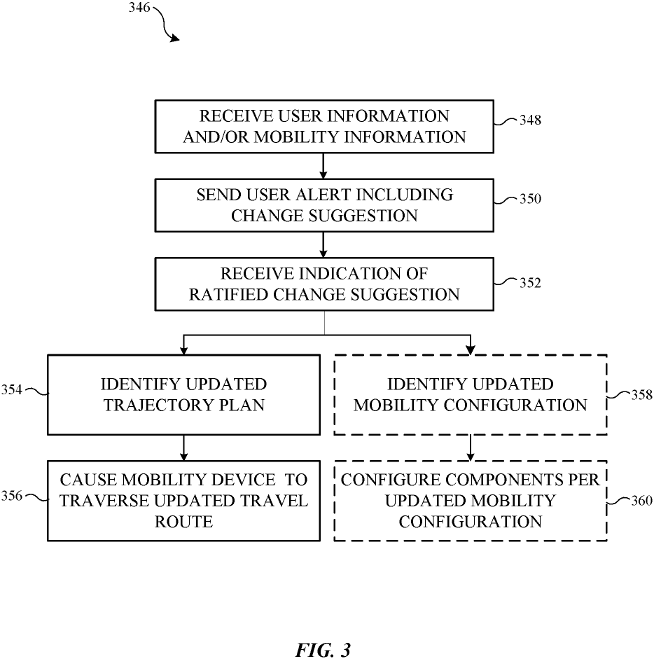

FIG. 3 is another flowchart describing a user-centered motion-planning process 346 using the mobile ecosystem 100 of FIG. 1. In step 348 of the process 346, a control system such as the autonomous control system 108 of FIG. 1 can receive or access user information and/or vehicle information (e.g., mobility information) from a user device such as the user device 104 and/or from a vehicle (e.g., a mobility device) such as the vehicle 102 of FIG. 1. The user information may include a user location, user calendar information, user biometric information, user location history information, user entertainment information, or user preference information as described with respect to FIG. 1. The vehicle information may include infrastructure information, route terrain information, route traffic information, a vehicle location, or vehicle location history information as described with respect to FIGS. 1 and 2.

In step 350 of the process 346, the control system can cause the user device or the vehicle to generate a user alert based on the user information or the vehicle information received or accessed in step 348 of the process 346. In some examples, the user alert may include a visual or audible warning to inform a user within the vehicle about a change in experience along a travel route. For example, either the user device or the vehicle may provide a visual notification or an audible notification that stop-and-go traffic is upcoming, that the vehicle is about to cross over speed bumps, or that a particularly curvy portion of the travel route is ahead should the user information or the vehicle information indicate that the user is, for example, reading a book or pulling out a laptop.

The user alert can serve as a courtesy, much like a traditional driver may warn a fellow passenger in a vehicle that driving conditions are about to change. In another example, the vehicle information or the user information may indicate that a passenger in the vehicle is partaking in food or drink, and a warning of additional upcoming motion may allow the passenger sufficient time to secure the food or drink to avoid spills. In another example, the user alert may provide an overview of the travel route, including an indication that a first portion of the travel route may include stop and go traffic, but a second portion of the travel route will include a smoother, lower vibration, lower acceleration or deceleration experience, such as consistent with components in the vehicle operating in a work configuration.

In some embodiments, the user alert of step 350 may include a change suggestion, that is, the control system may present an option to the user through the user device or the vehicle to modify either the trajectory plan or the vehicle configuration in which the vehicle is currently traversing the travel route. The control system may be configured to cause the user device or the vehicle to present the change suggestion to the user in a visual or an audible format. For example, if user information or vehicle information indicates that the user or other passengers within the vehicle appear to be sensing motion sickness, based on analysis of user information usable to identify changes in coloring, expression, posture, or activity level of the user or a passenger, the change suggestion may include suggesting a travel route with fewer curves, suggesting a pitstop along the travel route, suggesting a change to climate control settings to provide additional fresh air, suggesting repositioning of seats, suggesting opening windows of the vehicle, or suggesting multiple options to allow the user to select the preferred option, if any.

In step 352 of the process 346, the control system may receive an indication that a user ratifies the change suggestion. The user may provide such an indication by entering a user input to the user device or the vehicle, by making a gesture, or by providing a voice response, for example, to an audible change suggestion. Continuing the motion sickness example, the user may ratify adding a pitstop along the travel route, such as visiting a nearby rest area or stopping at a scenic overlook. The user may alternatively (or additionally) ratify a new travel route to reach the destination location that may add travel time but will include smoother, straighter roadways to mitigate motion sickness.

In step 354 of the process 346, the control system may identify an updated trajectory plan that identifies at least one of an updated departure time, an updated arrival time, or an updated travel route between the starting location and the destination location based on the ratified change suggestion. In step 356 of the process, the control system may cause the vehicle (e.g., the mobility device) to traverse the updated travel route. Continuing the motion sickness example, should the user make a choice to stop at a scenic overlook to quell motion sickness symptoms, the trajectory plan can be updated to include a stop at the scenic overlook, and the arrival time may also be updated accordingly.

In a parallel arm of the process 346, optional step 358 includes a control system such as the autonomous control system 108 of FIG. 1 identifying an updated vehicle configuration (e.g., an updated mobility configuration) based on a condition that the user ratifies the change suggestion in step 352. The updated vehicle configuration identifies updated travel settings for one or more components in at least one of the dynamic systems or the interior systems of the vehicle. In optional step 360 of the process, the control system may cause the one or more components to be configured according to the updated travel settings of the updated vehicle configuration (e.g., the updated mobility configuration). Continuing the motion sickness example, a user may select one or more of the multiple options described with respect to the change suggestion in step 350. These selections may lead the control system to cause a seat to rotate from rear-facing to front-facing, cause one or more windows to open to allow the passenger(s) to receive additional fresh air, cause a climate control system to direct fresh air toward specific passengers, or change other travel settings for various components during the optional step 360 of configuring components per the updated vehicle configuration.

Though a motion sickness example is described in association with the change suggestion presented in steps 350, 352, 354, 356, 358, and 360 of the process 346, other examples are possible. For example, change suggestions can be related to traffic changes prompting changes in travel route or changes in departure time, changes in user calendar information prompting changes in travel route to allow a smoother ride during a scheduled work call, or changes in user activity prompting changes in vehicle configuration to allow for increased user comfort. The types of user alerts and change suggestions can be many depending on content of received or accessed user information and/or vehicle information available to the control system.

Training for the control system that implements the processes 224, 346 of FIGS. 2 and 3 can be achieved both by requesting user input prior to vehicle operation and by receiving user feedback during vehicle operation. The control system may also include baseline travel settings associated with various vehicle configurations, such as different acceleration and decelerations thresholds for the work configuration and the sprint configuration. The control system may provide initial preference inquiries through interfaces within the vehicle and/or the user device to determine a user’s vibration tolerance, acceleration and deceleration tolerance, passing tolerance, following distance tolerance, vehicle configuration preference by user activity, etc. When the vehicle is traversing a travel route, the control system may request feedback to determine whether a user is comfortable during a certain maneuver to update a user profile to allow the control system to cause the vehicle to behave in a preferred way in the future. These inquiries may include asking whether a speed over a speedbump was too high, too low, or just right, whether a follow distance was too far, too close, or just right, or whether acceleration or deceleration was too abrupt, too sluggish, or just right. User inputs and user feedback may be used to update user preferences, for example, within the user profile 120 described with respect to FIG. 1.

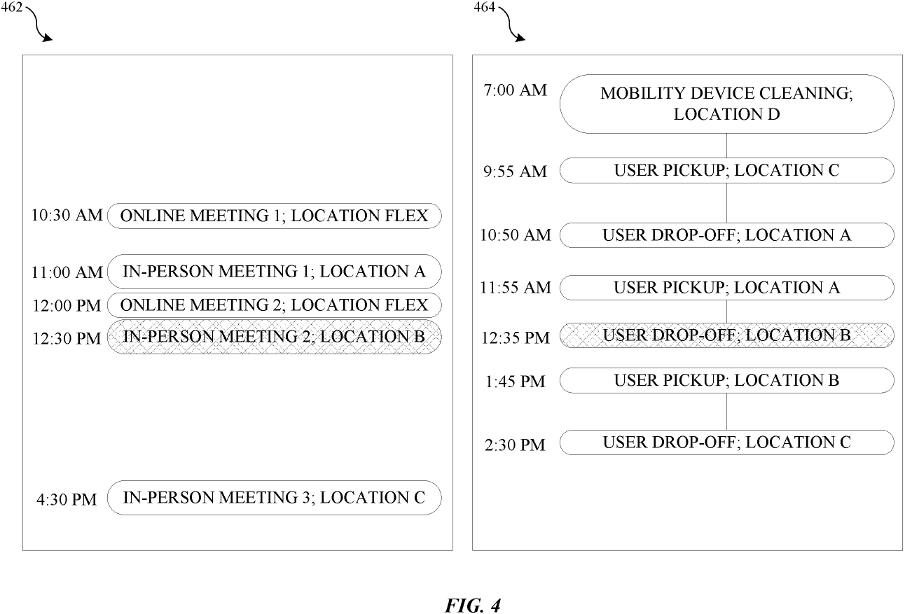

FIG. 4 is a calendar view for devices in the mobile ecosystem of FIG. 1. A user calendar 462, for example, associated with a user device such as the user device 104 of FIG. 1, is shown as including time-based user appointments on a single date (date not shown). A vehicle calendar 434, for example, associated with the control system 108 of the vehicle 102 of FIG. 1, is shown as including time-based vehicle appointments on the same single date. The user device and the vehicle (e.g., the mobility device) may be in communication via a network such as the network 122 of FIG. 1 to allow the control system to compare calendar information, a type of user information and vehicle information, between the calendars 462, 464 to support user-centered motion planning methods such as the processes 224, 346 of FIGS. 2 and 3.

Appointment information, a type of calendar information, may include time information, type information, participant information, and location information. For simplicity, the user-centered motion planning examples described with respect to FIG. 4 will be described using time information, type information, and location information associated with the user calendar 462 and the vehicle calendar 464. Though two calendars 462, 464 are shown, the appointment information may be present on a single calendar or additional calendars.

The user calendar 462 includes five appointments, time information is shown in hours and minutes for a beginning of an appointment, type information is shown as online meeting or in-person meeting, and location information is shown as specific (e.g., location A, location B, location C) or flexible (e.g., location flex). The vehicle calendar 464 includes seven appointments, time information is shown in hours and minutes for a beginning of an appointment, type information is shown as specific (e.g., vehicle cleaning, user pickup, or user drop-off), and location information is shown as specific (e.g., location A, location B, location C, or location D).

The control system, such as the control system 108 of the vehicle 102 of FIG. 1, can be configured to manage the vehicle calendar 464 and to cause the vehicle to travel to various locations associated with user appointments and vehicle appointments as part of a motion planning process. For example, a user may desire for the vehicle to receive a vehicle cleaning on the single date shown in the calendars 462, 464. Based on the appointments present on the user calendar 462, the control system may schedule the vehicle cleaning (e.g., the mobility device cleaning) at 7:00 AM on the vehicle calendar 464 at the location D, a location where cleaning services for the vehicle are available. The control system may also cause the vehicle to travel to the location D by the appointment time at 7:00 AM. The vehicle can travel to the location D without the user if driverless cleaning services are available.

After cleaning, the vehicle may be controlled to remain at the location D until the next relevant appointment or to travel to a storage location (not shown). The user calendar 462 indicates an online meeting 1 that occurs at 10:30 AM with a flexible location and an in-person meeting 1 that occurs at 11:00 AM at the location A. A user device (not shown) such as the user device 104 of FIG. 1 may also provide information to the control system that a user is currently present at the location C (e.g., a residence of the user). As the 10:30 AM online meeting 1 on the user calendar 462 has a flexible location and the 11:00 AM in-person meeting 1 on the user calendar 462 occurs at the location A (e.g., work), the control system can suggest to the user that the online meeting 1 be held in the vehicle and suggest a departure time from the location C, that is, the 9:55 AM user pickup, to support holding the online meeting 1 in the vehicle. The control system can cause the vehicle to travel from the location D to the location C as indicated by the line drawn between the 7:00 AM and 9:55 AM appointments on the vehicle calendar 464.

Assuming the user ratifies the 9:55 AM user pickup and plans to attend the 10:30 AM online meeting 1 in the vehicle, the control system can cause components within the vehicle to be configured with travel settings associated with a work configuration prior to or in conjunction with the 9:55 AM user pickup at the location C as shown on the vehicle calendar 464. This is useful, for example, to allow the user to remain at the location C (e.g., residence) until the vehicle is needed and available to take the user to the in-person meeting 1 at the location A (e.g., work). During the online meeting at 10:30 AM, the vehicle traverses a travel route between the location C and the location A to support a user drop-off at 10:50 AM at the location A as shown on the vehicle calendar 464. A line extends between the location C and the location A on the vehicle calendar 464 to represent the travel time. The vehicle may remain at the location A while the user attends the in-person meeting 1 at 11:00 AM at the location A. The next relevant appointments on the user calendar 462 are an online meeting 2 that occurs at 12:00 PM with a flexible location and an in-person meeting 2 that occurs at 12:30 PM at the location B (e.g., lunch).

The control system uses the flexible location of the 12:00 PM appointment on the user calendar 462 to schedule a user pickup at 11:55 AM at the location A and to suggest that the user attend the online meeting 2 at 12:00 PM in the vehicle while the vehicle concurrently traverses a travel route between the location A and the location B. The vehicle can remain in the work configuration from earlier in the day given that the online meeting 2 at 12:00 PM will be held in the vehicle. In some instances, the control system may need to react to manage conflicts. For example, the control system may receive updated vehicle information, such as traffic information, that indicates the travel time between the location A and the location B may take longer than planned, and the user may be at risk of being late for the in-person meeting 2 at 12:30 PM at the location B. This conflict between the calendars 462, 464 is shown by a hatched pattern on the 12:30 PM and 12:35 PM appointments on the user calendar 462 and the vehicle calendar 464, respectively.

Based on the conflict between the calendars 462, 464, the control system may cause a user alert to be sent, for example, to the user device and/or the vehicle. The user alert can include one or more change suggestions for ratification by the user. For example, the change suggestion could include a suggestion to reschedule the in-person meeting 2 at the location B from 12:30 PM to 12:35 PM. The change suggestion could include a suggestion to change the vehicle configuration from the work configuration to the sprint configuration, allowing the vehicle to reach the location B by the planned time of 12:30 PM for the in-person meeting 2 at the expense of ride comfort during the online meeting 2. The change suggestion could include a suggestion to send a message to other participants of the in-person meeting 2 at the location B that the user is running late. The user may ratify the desired suggestion, and the calendars 462, 464, the travel route, and/or the vehicle configuration may be updated by the control system and/or the user device accordingly. In another example, change suggestions may not be sent to the user in certain situations, such as when changes to the travel route cause a change in travel time less than 5 percent, less than 10 percent, etc.

Whether the vehicle and the user reach the location B at 12:30 PM or 12:35 PM, the vehicle may remain at the location B while the user is dropped off to attend the in-person meeting 2 at the location B. The next relevant appointment on the user calendar 462 is an in-person meeting 3 that occurs at 4:30 PM at the location C (e.g., home). The control system may rely on a scheduled duration, e.g., approximately an hour, of the 12:30 PM appointment on the user calendar 462 to schedule a user pickup at 1:45 PM at the location B. As the final appointment on the user calendar 462 is at the location C (e.g., home), the control system may send a user alert to request feedback from the user as to whether a return to the location A (e.g., work) is required between the 12:30 PM and 4:30 PM appointments on the user calendar 462.

Assuming no return to the location A (e.g., work) is indicated by the user, the control system may cause components within the vehicle the change from the work configuration to the relaxation configuration if the user profile or previous user feedback indicates that travel routes that end at the location C include travel settings consistent with the relaxation configuration. This is useful, for example, should the user have enjoyed a hearty lunch at the location B. The vehicle will then traverse a travel route between the location B and the location C as indicated with a line connecting the 1:45 PM and 2:30 PM user pickup and user drop-off on the vehicle calendar 464. The user will arrive at the location C at 2:30 PM per the vehicle calendar 464, allowing two hours of work or personal time for the user at the location C prior to the 4:30 PM in-person meeting 3 at the location C on the user calendar 462.

The user calendar 462 and the vehicle calendar 464 are shown as sources of user information and vehicle information used to support user-centered motion-planning processes for improving user convenience, comfort, and efficiency. A mobile ecosystem such as the mobile ecosystem 100 of FIG. 1 may also operate without calendar information, identifying trajectory plans and travel routes, sending user alerts, making change suggestions, and implementing various vehicle configurations such as work configurations, relaxation configurations, range configurations, and sprint configurations through use of other types of user information and vehicle information.

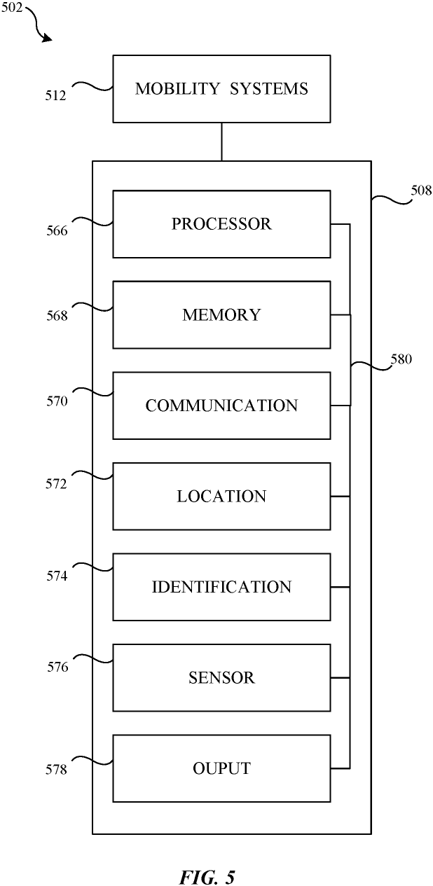

FIG. 5 is a diagram of an example of a vehicle 502 (e.g., a mobility device 502) in which the aspects, features, and elements disclosed herein can be implemented. FIG. 5 illustrates that the vehicle 502 includes an autonomous control system 508 which can be used to control a variety of vehicle systems 512 (e.g., mobility systems 512) of the vehicle 502. The vehicle 502 can include some or all the features of the vehicle 102 illustrated in FIG. 1, and the autonomous control system 508 can include some or all the features of the autonomous control system 108 illustrated in FIG. 1. The vehicle systems 512 can include some or all the features of the dynamic systems 112 and the interior systems 114 illustrated in FIG. 1, for example, including battery systems, powertrain systems, transmission systems, braking systems, steering systems, suspension systems, lighting systems, window systems, seating systems, climate control systems, entertainment systems (not shown), or any other systems used to provide user comfort and/or control movement of the vehicle 502.

The autonomous control system 508 of the vehicle 502 can include any combination of a processor 566, a memory 568, a communication component 570, a location component 472, an identification component 574, a sensor component 576, an output component 578, or a communication bus 580.

The processor 566 can execute one or more instructions such as the program instructions stored in the memory 568. As an example, the processor 566 can include one or more: central processing units (CPUs); general purpose processors with one or more processing cores; special purpose processors with one or more cores; digital signal processors (DSPs); microprocessors; controllers; microcontrollers; integrated circuits; Application Specific Integrated Circuits (ASIC); Field Programmable Gate Arrays (FPGA); or programmable logic controllers.

The memory 568 can include a tangible non-transitory computer-readable medium that can be used to store program instructions such as computer-readable instructions, machine-readable instructions, or any type of data that can be used by the processor 566. As an example, the memory 568 can include any computer readable media that can be accessed by the processor 566, such as read only memory (ROM) or random access memory (RAM). Further, the memory 568 can include volatile memory or non-volatile memory such as: solid state drives (SSDs), hard disk drives (HDDs), dynamic random access memory (DRAM); or erasable programmable read-only memory (EPROM).

The communication component 570 can be used to transmit or receive signals, such as electronic signals that include user information and/or vehicle information, via a wired or wireless medium. As an example, the communication component 570 can transmit or receive signals such as radio frequency (RF) signals which can be used to transmit or receive data that can be used by the processor 566 or stored in the memory 568.

The location component 572 can generate navigation data or geolocation data that can be used to determine a velocity, an orientation, a latitude, a longitude, or an altitude for the vehicle 502. The location component 572 can include one or more navigation devices that are able to use navigational systems such as GPS, the long range navigation system (LORAN), the Wide Area Augmentation System (WAAS), or the global navigation satellite system (GLONASS).

The identification component 574 can include specialized instructions for: operating the vehicle 502; communicating with remote data sources; determining the state of the vehicle 502; or determining the state or identity of extra-vehicular objects. In some implementations, a portion of the memory 568 can be coupled to the identification component 574 via the communication bus 580.

The sensor component 576 can include one or more sensors that detect the state or condition of the physical environment inside the vehicle 502 and the physical environment external to the vehicle 502. The sensor component 576 can include or be in communication with one or more sensors that detect the biometric features of the user of the vehicle 502. In some implementations, the sensor component 576 includes one or more of: an accelerometer, a gyroscope, a still image camera, a video camera, an infrared sensor, a LIDAR system, a radar system, a sonar system, a thermometer, a barometer, a moisture sensor, a vibration sensor, a capacitive input sensor, a heart rate sensor, or a resistive input sensor. As an example, the sensor component 576 can detect the state of stationary or moving objects including: physical structures such as buildings; vehicles such as automobiles and motorcycles; or non-vehicular entities such as pedestrians and vehicle drivers. Based on the sensory input detected by the sensor component 576, the sensor component 576 can generate sensor data that can be used to: operate the vehicle 502; determine the state or condition of the vehicle 502; or determine the state or condition of objects or users internal or external to the vehicle 502.

The output component 578 can include one or more output devices that can be used to generate outputs including sensory outputs such as visual outputs, audible outputs, haptic outputs, or electrical outputs. In some implementations, the one or more output devices can include: visual output components to display still or video images such as a liquid crystal display (LCD), an organic light-emitting diode (OLED) display, or a cathode ray tube (CRT) display; audio output components such as loudspeakers; or haptic output components to produce vibrations or other types of tactile outputs.

The communication bus 580 can include an internal bus or an external bus and can be used to couple any combination of the processor 566, the memory 568, the communication component 570, the location component 572, the identification component 574, the sensor component 576, or the output component 578. As an example, the communication bus 580 can include one or more buses such as: a peripheral component interconnect (PCI), Serial AT attachment (SATA), a HyperTransport (HT) bus, or a universal serial bus (USB).

As described above, one aspect of the present technology is the gathering and use of data available from various sources, such as from the sensor systems or components 106, 116, 576 or the user profile 120, to improve the function of a mobile ecosystem such as the mobile ecosystem 100 of FIG. 1 or the vehicle 502 of FIG. 5. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user’s health or level of fitness (e.g., vital signs measurements, medication information, exercise information), date of birth, or any other identifying or personal information.

The present disclosure recognizes that the use of personal information data, in the present technology, can be used to the benefit of users. For example, the personal information data can be used in a mobile ecosystem to best match user preferences or be stored and safeguarded, for example, in association with the user profile 120 in the user device 104. Other uses for personal information data that benefit the user are also possible. For instance, health and fitness data may be used to provide insights into a user’s general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user-profile-based mobile ecosystems, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can be implemented without the need for accessing such personal information data. That is, the various embodiments of the present technology are not rendered inoperable due to the lack of all or a portion of such personal information data. For example, changes in operation of a mobile ecosystem can be implemented for a given user by inferring user preferences or user status based on non-personal information data, a bare minimum amount of personal information, other non-personal information available to the system, or publicly available information.

What is claimed is:

1. A mobile ecosystem, comprising:
an autonomous control system in a vehicle configured to:
receive user information from at least one of a user device or the vehicle;
identify a trajectory plan and a vehicle configuration based on the user information,
wherein the trajectory plan identifies a departure time for the vehicle to depart a starting location, an arrival time for the vehicle to arrive at a destination location, and a travel route for the vehicle to traverse at least partially between the starting location and the destination location, and
wherein the vehicle configuration identifies travel settings for components in at least one of dynamic systems or interior systems of the vehicle;
cause the components to be configured according to the travel settings; and
cause the vehicle to traverse the travel route.

2. The mobile ecosystem of claim 1, wherein the autonomous control system is further configured to:
cause the components to be configured according to the travel settings prior to causing the vehicle to traverse the travel route.

3. The mobile ecosystem of claim 1, wherein the user information includes at least one of a user location, user calendar information, user biometric information, user location history information, user entertainment information, or user preference information.

4. The mobile ecosystem of claim 3, wherein the trajectory plan identifies an entry time for a user to enter the vehicle based on at least one of the user entertainment information or the user calendar information, the entry time prior to the departure time.

5. The mobile ecosystem of claim 1, wherein the autonomous control system is further configured to:
receive updated user information from at least one of the user device or the vehicle;
identify an updated vehicle configuration based on the updated user information, wherein the updated vehicle configuration identifies updated travel settings for one or more components in the at least one of the dynamic systems or the interior systems of the vehicle; and
cause the one or more components to be configured according to the updated travel settings.

6. The mobile ecosystem of claim 5, wherein the autonomous control system is further configured to:
identify an updated trajectory plan based on the updated user information, wherein the updated trajectory plan identifies an updated travel route; and
cause the vehicle to traverse the updated travel route.

7. The mobile ecosystem of claim 1, wherein the autonomous control system is further configured to:
receive vehicle information from the vehicle, wherein the vehicle information includes at least one of infrastructure information, route terrain information, route traffic information, a vehicle location, or vehicle location history information.

8. The mobile ecosystem of claim 7, wherein the autonomous control system is further configured to:
cause the user device or the vehicle to generate a user alert based on at least one of the user information or the vehicle information.

9. The mobile ecosystem of claim 8, wherein the user alert includes a change suggestion, and wherein the autonomous control system is further configured to:
cause the user device or the vehicle to present the change suggestion to the user;
upon a condition that the user ratifies the change suggestion, identify an updated trajectory plan that identifies at least one of an updated departure time, an updated arrival time, or an updated travel route between the starting location and the destination location based on the change suggestion; and
cause the vehicle to traverse the updated travel route.

10. The mobile ecosystem of claim 9, wherein the autonomous control system is further configured to:
upon a condition that the user ratifies the change suggestion, identify an updated vehicle configuration based on the change suggestion, wherein the updated vehicle configuration identifies updated travel settings for one or more components in the at least one of the dynamic systems or the interior systems of the vehicle; and
cause the one or more components to be configured according to the updated travel settings.

11. A motion-planning method, comprising:
obtaining user information from at least one of a user device or a vehicle;
obtaining vehicle information from at least one of the user device or the vehicle;
identifying a trajectory plan and a vehicle configuration based on the user information and the vehicle information,
wherein the trajectory plan identifies a travel route for the vehicle to traverse at least partially between a starting location and a destination location, and
wherein the vehicle configuration identifies travel settings for components in at least one of dynamic systems or interior systems of the vehicle;
configuring the components according to the travel settings; and
after configuring the components according to the travel settings, causing the vehicle to traverse the travel route.

12. The motion-planning method of claim 11, further comprising:
obtaining updated user information from at least one of the user device or the vehicle;
sending a change suggestion to one of the user device or the vehicle; and
upon a condition that a user ratifies the change suggestion, identifying an updated vehicle configuration based on the updated user information, wherein the updated vehicle configuration identifies updated travel settings for one or more components in the dynamic systems or the interior systems of the vehicle; and
configuring the one or more components according to the updated travel settings.

13. The motion-planning method of claim 11, further comprising:
obtaining updated vehicle information from the vehicle;
sending a change suggestion to one of the user device or the vehicle;
upon a condition that a user ratifies the change suggestion, identifying an updated travel route for the vehicle to traverse at least partially between the starting location and the destination location; and
causing the vehicle to traverse the updated travel route.

14. The motion-planning method of claim 11, wherein the user information includes at least one of a user location, user calendar information, user biometric information, user location history information, user entertainment information, or user preference information.

15. The motion-planning method of claim 14, wherein the trajectory plan identifies a departure time for the vehicle to depart the starting location, an arrival time for the vehicle to arrive at the destination location, and an entry time for a user to enter the vehicle based on at least one of the user calendar information or the user entertainment information, the entry time being prior to the departure time.

16. The motion-planning method of claim 15, further comprising:
sending a user alert to the user device, the user alert configured to identify the entry time for the user to enter the vehicle.

17. The motion-planning method of claim 11, wherein the vehicle information includes at least one of infrastructure information, route terrain information, route traffic information, a vehicle location, or vehicle location history information.

18. An autonomous control system for a vehicle, the autonomous control system configured to:
obtain user information pertaining to a user of the vehicle;
obtain vehicle information pertaining to the vehicle;
identify a vehicle configuration based on at least one of the user information or the vehicle information, wherein the vehicle configuration identifies travels settings for components in at least one of dynamic systems or interior systems of the vehicle; and
cause the components to be configured according to the travel settings.

19. The autonomous control system of claim 18, wherein the vehicle configuration identifies travel settings for components in the dynamic systems, and wherein the travel settings include at least one of suspension settings, powertrain settings, steering settings, or braking settings.

20. The autonomous control system of claim 18, wherein the vehicle configuration identifies travel settings for components in the interior systems, and wherein the travel settings include at least one lighting levels, climate control settings, tinting settings, audio settings, and positions of seats within the vehicle.
